(19) United States
(12) Patent Application Publication
(10) Pub. No.: US 2020/0339161 A1
(43) Pub. Date: Oct. 29, 2020

(54) AUTONOMOUS DRIVING DELIVERY SYSTEM

(71) Applicant: Toyota Jidosha Kabushiki Kaisha, Toyota-shi Aichi-ken (JP)

(72) Inventors: Sho Otaki, Yokohama-shi (JP); Takayuki Iwamoto, Sunto-gun (JP)

(21) Appl. No.: 16/851,668

(22) Filed: Apr. 17, 2020

(30) Foreign Application Priority Data
Apr. 24, 2019 (JP) 2019-082592

(51) Int. Cl. B60W 60/00; G01C 21/34; G06Q 10/02; G06Q 50/30

(52) U.S. Cl. CPC B60W 60/00256; B60W 60/0023; G06Q 50/30; G01C 21/3469; G06Q 10/02; G01C 21/3461

(57) ABSTRACT

An autonomous driving delivery system includes a first selection unit configured to select a first candidate delivery location based on a position of the user or the like, a determination unit configured to determine whether or not the autonomous driving vehicle can reach the first candidate delivery location, a second selection unit configured to select a second candidate delivery location where the autonomous driving vehicle can reach if it is determined that the autonomous driving vehicle cannot reach the first candidate delivery location, a designation unit configured to designate the first candidate delivery location or the second candidate delivery location as the delivery location, and a presentation unit configured to present the designated delivery location to the user before the autonomous driving vehicle starts the delivery of the luggage to the designated delivery location.

### CROSS-REFERENCE TO RELATED APPLICATION

This application claims the benefit of priority from Japanese Patent Application No. 2019-082592, filed on Apr. 24, 2019, the entire contents of which are incorporated herein by reference.

### TECHNICAL FIELD

The present disclosure relates to an autonomous driving delivery system.

### BACKGROUND

In the related art, it has been considered to autonomously deliver pieces of luggage using an autonomous driving vehicle. For example, U.S. Pat. No. 9,547,307 discloses a vehicle allocation and a delivery service using an autonomous driving vehicle.

### SUMMARY

For example, when delivering pieces of luggage using an autonomous driving vehicle, even if the delivery is started toward a predetermined delivery location, it may be assumed that the luggage cannot reach the delivery location due to road situations. In such a case, it may be possible to present another reachable delivery location to a user, but since the delivery location is changed during the delivery, the user may feel discomfort. For this reason, in this technical field, there is a demand for an autonomous driving delivery system that can appropriately present the luggage delivery location to the user.

An autonomous driving delivery system according to an aspect of the present disclosure is a system for delivering luggage to a delivery location by an autonomous driving vehicle based on a delivery request for delivering the luggage to a user. The system includes: a first selection unit configured to select a first candidate delivery location from a plurality of predetermined stop locations based on a position of the user, a past delivery history to the user or the delivery location specified by the user, when the delivery request is made; a determination unit configured to determine whether or not the autonomous driving vehicle can reach the first candidate delivery location based on at least one of a cruising available distance and road passability information of the autonomous driving vehicle; a second selection unit configured to select a second candidate delivery location where the autonomous driving vehicle can reach, from the plurality of stop locations based on at least any one of the cruising available distance and the road passability information, if it is determined that the autonomous driving vehicle cannot reach the first candidate delivery location; a designation unit configured to designate the first candidate delivery location as the delivery location if it is determined that the autonomous driving vehicle can reach the first candidate delivery location, and configured to designate the second candidate delivery location as the delivery location if it is determined that the autonomous driving vehicle cannot reach the first candidate delivery location; and a presentation unit configured to present the designated delivery location to the user before the autonomous driving vehicle starts the delivery of the luggage to the delivery location designated by the designation unit.

In the autonomous driving delivery system, if the vehicle can reach the first candidate delivery location, the first candidate delivery location is designated as the delivery location, and if the vehicle cannot reach the first candidate delivery location, the second candidate delivery location is designated as the delivery location. The designated delivery location is presented to the user before the autonomous driving vehicle starts the delivery of the luggage to the delivery location. As described above, if the vehicle cannot reach the first candidate delivery location, the autonomous driving delivery system can designate the second candidate delivery location as the delivery location, and can start the delivery of the luggage after presenting the designated delivery location to the user. Therefore, the delivery location is not changed during the delivery, and thus, it is possible to prevent the user from feeling discomfort. In this way, the autonomous driving delivery system can appropriately present the luggage delivery location to the user more.

In the autonomous driving delivery system, the second selection unit may be configured to select a plurality of second candidate delivery locations from the plurality of stop locations based on at least one of the cruising available distance and the road passability information, the presentation unit may be configured to present the plurality of second candidate delivery locations selected by the second selection unit to the user if it is determined that the autonomous driving vehicle cannot reach the first candidate delivery location, and the designation unit may be configured to designate the second candidate delivery location selected by the user as the delivery location. In this case, the autonomous driving delivery system can designate the second candidate delivery location selected by the user as the delivery location if the vehicle cannot reach the first candidate delivery location. In this way, if the vehicle cannot reach the first candidate delivery location, the autonomous driving delivery system can reflect the user's desire on the delivery location, and thus, it is possible to improve the convenience for the user.

In the autonomous driving delivery system, the determination unit may be configured to determine that the autonomous driving vehicle cannot reach the first candidate delivery location based on the cruising available distance and the road passability information if the autonomous driving vehicle cannot return to a predetermined fueling or charging place via the first candidate delivery location. In this case, if the first candidate delivery location is the delivery location, the autonomous driving delivery system can prevent the autonomous driving vehicle from being not possible to return to the fueling or charging place.

In the autonomous driving delivery system, the stop location may be a location where parking or stopping of the autonomous driving vehicle is not legally prohibited. In this case, the autonomous driving delivery system can select a location at which the parking or stopping is not legally prohibited as the first candidate delivery location or the second candidate delivery location. In this way, the autonomous driving delivery system can receive and transfer the luggage by stopping the autonomous driving vehicle at the stop location while keeping the law.

In the autonomous driving delivery system, the stop location may be a location on the road satisfying condition in which road width divided by vehicle width of autonomous driving vehicle is equal to or greater than a predetermined ratio threshold value. In this case, the autonomous driving delivery system can select a location whose road width is wider than the vehicle width of the autonomous driving vehicle by the predetermined ratio threshold value as the first candidate delivery location or the second candidate delivery location. In this way, the autonomous driving delivery system can stop the autonomous driving vehicle at the stop location and can receive and transfer the luggage while suppressing hindrance of the traveling of other vehicles on the road.

In the autonomous driving delivery system, the stop location may be a location provided with a parking section where the autonomous driving vehicle can be parked or stopped. In this case, the autonomous driving delivery system can stop the autonomous driving vehicle and receive and transfer the luggage at the location (the location where the parking section is provided) provided in advance for parking or stopping.

According to an aspect of the present disclosure, the luggage delivery location can be appropriately presented to the user.

### BRIEF DESCRIPTION OF THE DRAWINGS

FIG. 1 is a diagram illustrating an example of a configuration of an autonomous driving delivery system according to an embodiment.

FIG. 2 is a diagram illustrating an example of a hardware configuration of a server.

FIG. 3 is a diagram illustrating an example of a functional configuration of a user's mobile terminal, an autonomous driving vehicle, and the server.

FIG. 4 is a flowchart illustrating delivery location presentation processing performed by the server.

### DETAILED DESCRIPTION

Embodiments of the present disclosure will be described with reference to the drawings. In the description of the drawings, the same reference numerals will be given to the same elements, and the descriptions thereof will not be repeated.

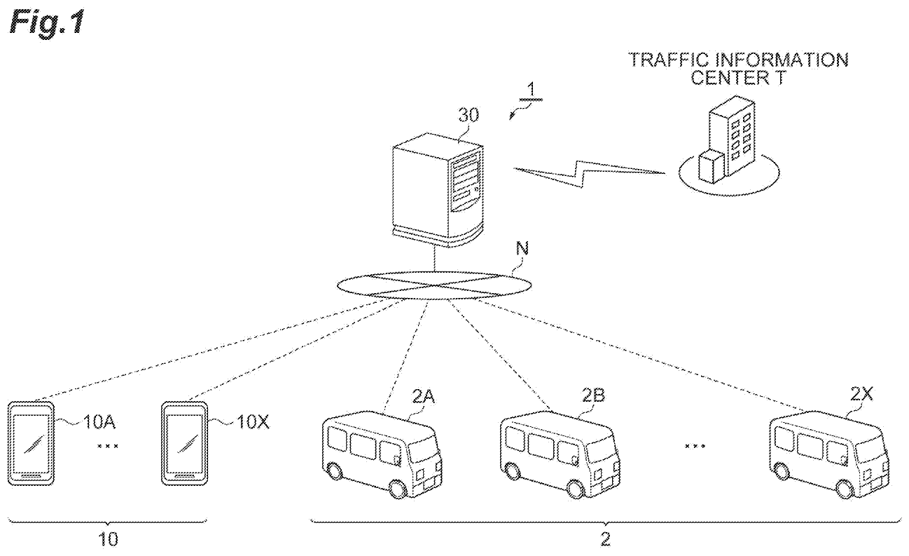

The autonomous driving delivery system 1 illustrated in FIG. 1 is a system for delivering luggage by an autonomous driving vehicle toward a delivery location based on a delivery request for delivering the luggage to a user. The autonomous driving vehicle is a vehicle having an autonomous driving function for autonomously driving the vehicle toward a location set in advance. In the autonomous driving vehicle, the driver does not need to perform driving operation and travels autonomously. The autonomous driving vehicle includes various sensors, cameras, actuators, and the like for realizing the autonomous driving function. A person may or may not be in the autonomous driving vehicle. The autonomous driving vehicle performs the autonomous driving that travels toward the delivery location set by the autonomous driving delivery system 1 as a destination.

The autonomous driving vehicle has delivery boxes for loading the pieces of luggage, for example. For example, a plurality of delivery boxes are provided adjacent to each other vertically and horizontally, and each delivery box has an opening and closing door at the same direction. The delivery box is provided with a common input terminal in the same direction as the opening and closing door of each delivery box, the locked delivery box can be unlocked by inputting a passcode sent to the user's mobile terminal into the input terminal. A shape and a method of unlocking the delivery box are not particularly limited, and various modes can be adopted.

### Configuration of Autonomous Driving Delivery System

As illustrated in FIG. 1, the autonomous driving delivery system 1 includes a server 30. The server 30 is installed in a facility, for example. The server 30 may be configured with the servers or computers provided at a plurality of locations. The server 30 is configured to be able to communicate with the autonomous driving vehicles 2A, 2B, . . . , 2X and the user's mobile terminals 10A, 10B, . . . , 10X via the network N. The network N is a wireless communication network.

The numbers of autonomous driving vehicles 2A . . . 2X and the mobile terminal 10A . . . 10X are not particularly limited. Hereinafter, the description will be made using the autonomous driving vehicle 2 as a representative of the autonomous driving vehicles 2A . . . 2X, and the mobile terminal 10 as a representative of the mobile terminals 10A . . . 10X.

When receiving luggage delivery request from the mobile terminal 10, the server 30 instructs the autonomous driving vehicle 2 on which the corresponding luggage of the user is loaded among the autonomous driving vehicles 2 to deliver the luggage by the autonomous driving. In addition, the server 30 is configured to be able to communicate with a traffic information center T. The server 30 acquires a road passability information from the traffic information center T. The server 30 may be connected to the traffic information center T via the network N.

Here, the road passability information is information indicating whether each location on the road is accessible or not. This passability means whether or not the autonomous driving vehicle 2 can travel by the autonomous driving. The traffic information center T collects the road passability information based on road close information, construction information, accident information, and the like using various known methods. The traffic information center T may collect the road passability information based on the traveling result of the autonomous driving of the autonomous driving vehicle 2. In this case, for example, the location where the road passability information indicates that the vehicle cannot access may include a location where the autonomous driving vehicle 2 cannot pass during the autonomous driving, or a location where a remote operation by an operator is required without passing by the autonomous driving (driving operation by the operator).

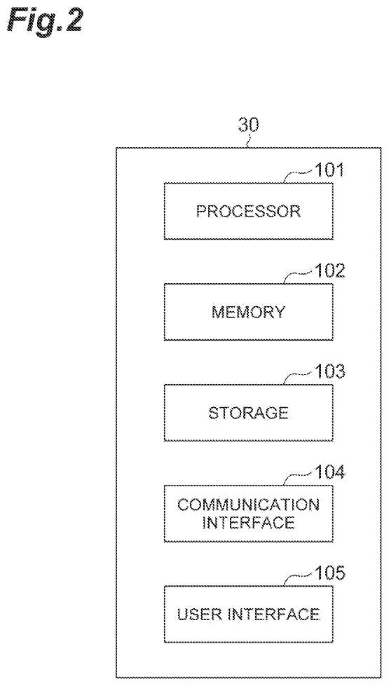

Here, FIG. 2 is a diagram illustrating an example of a hardware configuration of the server 30. As illustrated in FIG. 2, the server 30 can be configured as a general computer including a processor 101, a memory 102, a storage 103, a communication interface 104, and a user interface 105.

The processor 101 is an arithmetic operation unit such as a central processing unit (CPU). The memory 102 is a storage medium such as a read only memory (ROM) or a random access memory (RAM). The storage 103 is a storage medium such as a hard disk drive (HDD). The communication interface 104 is a communication device that realizes data communication. The user interface 105 is an output device such as a liquid crystal or a speaker, and an input device such as a touch panel or a microphone. The processor 101 realizes various functions of the server 30 by performing overall management of the memory 102, the storage 103, the communication interface 104, and the user interface 105. The mobile terminal 10 can adopt the same configuration as the hardware configuration. In the case of the mobile terminal 10, a flash memory may be used as the storage 103, or an online storage may be used.

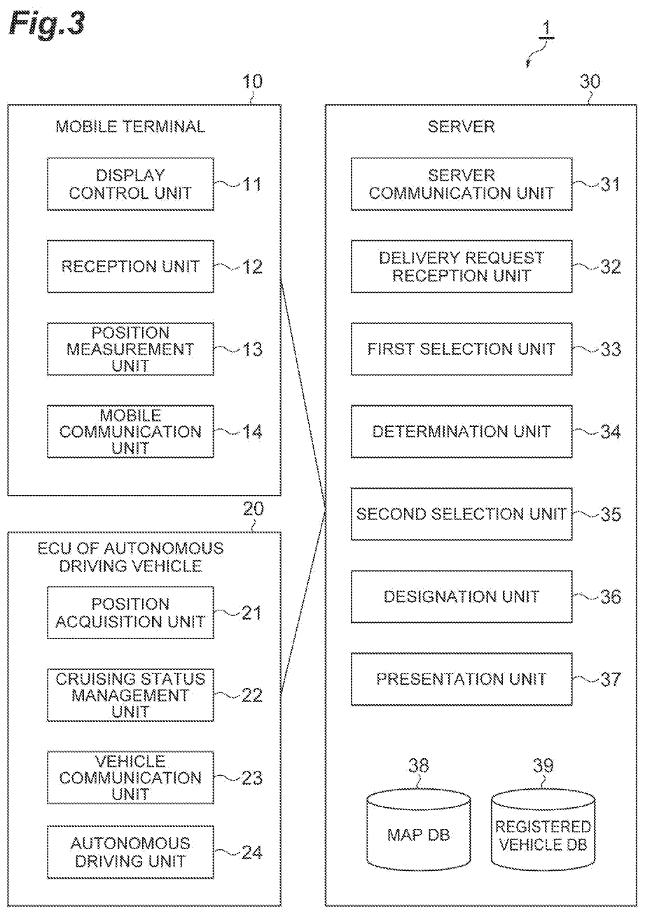

FIG. 3 is a diagram illustrating an example of functional configurations of the user's mobile terminal 10, the autonomous driving vehicle 2 (an ECU 20 of the autonomous driving vehicle 2), and the server 30. As illustrated in FIG. 3, the user's mobile terminal 10 includes a display control unit 11, a reception unit 12, a position measurement unit 13, and a mobile communication unit 14.

The display control unit 11 displays various displays on the screen of the mobile terminal 10. The display control unit 11 displays the luggage delivery location received from the server 30 on the screen. The display control unit 11 performs display for the user to make luggage delivery request. The display control unit 11 can perform a display for selecting the luggage delivery location. The display control unit 11 may display the content of the luggage or the delivery status of the luggage on the screen, for example, by the user's operation.

The reception unit 12 receives the user's operation. The reception unit 12 recognizes the user's operation by receiving an operation of a button of the mobile terminal 10 performed by the user, and/or an input to the touch panel. Here, the reception unit 12 receives an input operation for the luggage delivery request performed by the user. In addition, the reception unit 12 can receive an operation for selecting the luggage delivery location performed by the user.

The position measurement unit 13 measures a position of the mobile terminal 10 using a GPS receiver or the like incorporated in the mobile terminal 10. The position measurement unit 13 may be capable of performing the position measurement using base station information of the communication. The method of measuring the position of the mobile terminal 10 is not particularly limited.

The mobile communication unit 14 manages the communication of the mobile terminal 10. The mobile communication unit 14 communicates with the server 30 and the mobile terminal 10 by being connected to the network N.

For example, if a user performs an operation to transmit the luggage delivery request, the mobile terminal 10 transmits the delivery request to the server 30 through the mobile communication unit 14. At this time, the mobile terminal 10 may transmit position information relating to the position of the mobile terminal 10 to the server 30 together with the delivery request. The mobile terminal 10 may be configured to transmit the position information on the mobile terminal 10 to the server 30 after receiving the position information transmission request from the server 30.

The autonomous driving vehicle 2 includes an electronic control unit (ECU) 20. The ECU 20 is an electronic control unit including a CPU, a ROM, a RAM, and the like. As illustrated in FIG. 3, the ECU 20 includes a position acquisition unit 21, a cruising status management unit 22, a vehicle communication unit 23, and an autonomous driving unit 24.

The position acquisition unit 21 acquires a position of the autonomous driving vehicle 2 on the map based on position information and map information of the vehicle-mounted GPS receiver.

The cruising status management unit 22 manages a cruising available distance of the autonomous driving vehicle 2. The cruising available distance means a remaining distance that the vehicle can travel in the current state without fueling or charging. For example, if the autonomous driving vehicle 2 is a vehicle that has a gasoline engine or diesel engine as a drive source, the cruising status management unit 22 may estimate the cruising available distance based on the remaining amount of gasoline or diesel oil. For example, if the autonomous driving vehicle 2 is an electric autonomous vehicle, the cruising status management unit 22 may estimate the cruising available distance based on the amount of power remaining in a battery. The cruising status management unit 22 can estimate the cruising available distance using various known methods.

The vehicle communication unit 23 manages communication of the autonomous driving vehicle 2. The vehicle communication unit 23 communicates with the server 30 and the autonomous driving vehicle 2 by being connected to the network N. The vehicle communication unit 23 transmits the position information on the autonomous driving vehicle 2 to the server 30 via the network N. The vehicle communication unit 23 transmits the cruising available distance of the autonomous driving vehicle 2 to the server 30 via the network N.

The autonomous driving unit 24 performs the autonomous driving of the autonomous driving vehicle 2. The autonomous driving unit 24 performs the autonomous driving by controlling various actuators (for example, an engine actuator, a brake actuator, and a steering actuator) of the autonomous driving vehicle 2.

The autonomous driving unit 24 performs the autonomous driving such that the autonomous driving vehicle 2 arrives at a plurality of predetermined stop locations. The stop location is a location at which the autonomous driving vehicle 2 can stop for delivering the luggage. The location may include only one parking space or a plurality of parking spaces. The stop location is a location at which parking or stopping of the autonomous driving vehicle 2 is not legally prohibited. The stop location may be a location provided with a parking section in which the autonomous driving vehicle 2 can park or stop. The parking section may be provided in a parking lot, for example. The stop location may be a parking lot of a store such as a convenience store.

The stop location may be a location on the road. The stop location can be a location on the road of which a road width is equal to or wider than a road width threshold value. The stop location may be a location on the road that satisfies a condition that “road width divided by vehicle width of the autonomous driving vehicle is equal to or greater than a predetermined ratio threshold value”. As described above, the stop location may be a location having a sufficiently wide road width compared to the vehicle width of the autonomous driving vehicle 2. The stop location may be a location on the road with a roadside zone. Each of the above threshold values is a predetermined set value. Various threshold values described below are also a predetermined set values.

The stop location may be a location on the road having a sidewalk, and may be a location on the road where a vehicle lane and a sidewalk are not separated by a structure such as a guardrail. The stop location may be a road whose curvature is limited to be equal to or greater than a curvature threshold value. The stop location may be a road where the slope is limited to be less than a slope threshold value. The stop location may be an area extending along the road. The stop location may be a location where the step when entering the location from the road is less than a step threshold value among the locations where the vehicle can stop.

When receiving a delivery order from the server 30 via the vehicle communication unit 23, the autonomous driving unit 24 performs the autonomous driving of the autonomous driving vehicle 2 so as to reach the delivery location designated from the stop locations. The designation of the delivery location will be described later.

The ECU 20 transmits the position information on the autonomous driving vehicle 2 (the position information from the vehicle-mounted GPS receiver) and the cruising available distance, to the server 30 through the vehicle communication unit 23. For example, the ECU 20 may transmit the position information and the cruising available distance to the server 30 at a predetermined cycle.

As illustrated in FIG. 3, the server 30 includes a server communication unit 31, a delivery request reception unit 32, a first selection unit 33, a determination unit 34, a second selection unit 35, designation unit 36, a presentation unit 37, a map DB 38, and a registered vehicle DB 39. In addition, the server 30 has information relating to the delivery of the luggage.

The server communication unit 31 manages the communication between the server 30, the mobile terminal 10, and the autonomous driving vehicle 2. The server communication unit 31 may transmit the information relating to the delivery of the luggage to the autonomous driving vehicle 2 in response to the request from the user's mobile terminal 10. Furthermore, the server communication unit 31 manages the communication with the traffic information center T.

The delivery request reception unit 32 receives a delivery request transmitted from the user's mobile terminal 10. The delivery request is a request to deliver the luggage to the user. The luggage means the luggage to be delivered by the autonomous driving vehicle 2. For example, the user operates the mobile terminal 10 and transmits the delivery request to the server 30. In addition, the user may transmit the information on the delivery location where the luggage is desired to be delivered, to the server 30 together with the delivery request. The autonomous driving vehicle 2 appears in delivery location designation processing performed by the server 30 or the like described below is the autonomous driving vehicle 2 on which the luggage of the user who made the delivery request is loaded.

When the delivery request is performed, the first selection unit 33 selects a first candidate delivery location from a plurality of predetermined stop locations. The first candidate delivery location is a location that can be luggage delivery location based on a result of determination performed by the determination unit 34. In addition, the first candidate delivery location is a location that can be a delivery location according to the selection by the user and the result of determination of the determination unit 34 if a plurality of first candidate delivery locations are selected as will be described later.

Here, the first selection unit 33 selects the first candidate delivery location based on the position of the user, the past delivery history to the user, or the delivery location specified by the user. Specifically, when selecting the first candidate delivery location based on the position of the user, the first selection unit 33 selects the first candidate delivery location from a plurality of stop locations based on the position information (information on the position of the user) on the mobile terminal 10, which was transmitted from the mobile terminal 10. For example, the first selection unit 33 can select the stop location closest to the position of the user as the first candidate delivery location. The first selection unit 33 may select the stop location having the shortest straight line distance from the position of the user as the first candidate delivery location, or may select the stop location having the shortest distance from the position of the user (the distance along the road) as the first candidate delivery location.

In addition, when selecting the first candidate delivery location based on the past delivery history to the user, the first selection unit 33 can select the stop location which is most frequently used when delivering the luggage to the user, as a first candidate delivery location. When selecting the first candidate delivery location based on the past delivery history to the user, the first selection unit 33 can select the stop location which was most recently used when delivering the luggage to the user, as the first candidate delivery location.

In addition, when selecting the first candidate delivery location based on the delivery location specified by the user, the first selection unit 33 can select the stop location corresponding to (matching) the delivery location desired by the user or the nearest stop location based on the information on the desired delivery location transmitted from the user together with the delivery request, as the first candidate delivery location.

The first selection unit 33 is not limited to select only one first candidate delivery location, but may select a plurality of first candidate delivery locations. In this case, the first selection unit 33 may select a plurality of first candidate delivery locations based on at least one of the position of the user, the past delivery history to the user, and the delivery locations specified by the user.

The determination unit 34 determines whether or not the autonomous driving vehicle 2 can reach the first candidate delivery location selected by the first selection unit 33 based on at least one of the cruising available distance and the road passability information of the autonomous driving vehicle 2.

For example, when determining based on the cruising available distance, the determination unit 34 determines whether or not the vehicle can reach the first candidate delivery location in current state of the current autonomous driving vehicle 2 without fueling or charging. Specifically, for example, the determination unit 34 can determine whether or not the vehicle can reach the first candidate delivery location from the current position of the autonomous driving vehicle 2 based on the cruising available distance, the position of the autonomous driving vehicle 2 (current position), and the map information in the map DB 38 by the autonomous driving. Here, when the determination unit 34 determines whether or not the vehicle can reach the first candidate delivery location, the determination can be performed based on the distance from the position of the autonomous driving vehicle 2 to the first candidate delivery location by the autonomous driving (the distance along the road obtained based on map information) and the cruising available distance.

In addition, when determining whether or not the vehicle can reach the first candidate delivery location based on the cruising available distance, if it is not possible to return to the predetermined fueling or charging place from the current position of autonomous driving vehicle 2 via the first candidate delivery location, the determination unit 34 may determine that the vehicle cannot reach the first candidate delivery location. In this case, the determination unit 34 may add whether or not the vehicle can return to the fueling or charging place at the predetermined date and time to a determination condition. That is, if it is not possible to return to the fueling or charging place from the current position of the autonomous driving vehicle 2 via the first candidate delivery location by the predetermined day and time, the determination unit 34 may determine that the vehicle cannot reach the first candidate delivery location. The fueling or charging place is a place where facilities for supplying gasoline or the like to the autonomous driving vehicle 2 is provided, or a place where facilities for charging the autonomous driving vehicle 2 is provided.

For example, when performing the determination based on the road passability information, the determination unit 34 can determine whether or not the vehicle can reach the first candidate delivery location from the current position of the autonomous driving vehicle 2 by the autonomous driving based on the road passability information, the position of the autonomous driving vehicle 2 (current position), and the map information in the map DB 38. For example, if all the roads to the first candidate delivery location are closed, the determination unit 34 determines that the vehicle cannot reach the first candidate delivery location. In addition, When performing the determination whether or not the vehicle can reach the first candidate delivery location based on the road passability information, if it is not possible to return to the predetermined fueling or charging place from the current position of the autonomous driving vehicle 2 via the first candidate delivery location (if there is no route to return), the determination unit 34 may determine that the vehicle cannot reach the first candidate delivery location.

In addition, the determination unit 34 may determine whether or not the vehicle can reach the first candidate delivery location by combining the above-described determination processing based on both the cruising available distance and the road passability information.

If it is determined that the autonomous driving vehicle 2 cannot reach the first candidate delivery location, the second selection unit 35 selects a stop location where the autonomous driving vehicle 2 can reach as a second candidate delivery location from a plurality of stop locations, based on at least one of the cruising available distance and the road passability information. The second candidate delivery location is a location that is luggage delivery location. In addition, the second candidate delivery location means a location that can be the delivery location depending on the user's selection when a plurality of second candidate delivery locations are selected as described later.

Specifically, for example, the second selection unit 35 can select a reachable stop location as a second candidate delivery location based on the cruising available distance, the position of the autonomous driving vehicle 2 (current position), the road passability information, and the map information in the map DB 38. In this case, the second selection unit 35 may select a stop location that is reachable and closest to the first candidate delivery location among the plurality of stop locations, as the second candidate delivery location. Here, the second selection unit 35 can select the second candidate delivery location based on the distance to reach each stop location by the autonomous driving (distance along the road obtained based on the map information) while avoiding the closed locations on the road from the current position of autonomous driving vehicle 2 and the cruising available distance.

The second selection unit 35 is not limited to select only one second candidate delivery location, but may select a plurality of second candidate delivery locations. For example, the second selection unit 35 may select the predetermined number of stop locations as the second candidate delivery locations from in an order of the stop locations closest to the first candidate delivery location among the reachable stop locations. In addition, the second selection unit 35 is not limited to use both the cruising available distance and the road passability information, but may use any one of them.

If it is determined by the determination unit 34 that the autonomous driving vehicle 2 can reach the first candidate delivery location, the designation unit 36 designates the first candidate delivery location as luggage delivery location. The designation unit 36 transmits a delivery order to the autonomous driving vehicle 2 on which the luggage of the user who made the delivery request is loaded, based on the designated delivery location. In this delivery order, the information on the designated delivery location (the selected first candidate delivery location) is included. In this delivery order, information on the route when the determination unit 34 determines that the vehicle can reach the first candidate delivery location may be included.

In addition, if it is determined by the determination unit 34 that the autonomous driving vehicle 2 cannot reach the first candidate delivery location, the designation unit 36 designates the second candidate delivery location as the luggage delivery location. The designation unit 36 transmits a delivery order to the autonomous driving vehicle 2 on which the luggage of the user who made the delivery request is loaded, based on the designated delivery location. This delivery order includes information on the designated delivery location (selected second candidate delivery location). In this delivery order, the route information when the second selection unit 35 determines that the vehicle can reach the second candidate delivery location.

The presentation unit 37 presents (transmits) the designated delivery location to the mobile terminal 10 of the user who made the delivery request before the autonomous driving vehicle 2 starts to deliver the luggage toward the delivery location designated by the designation unit 36.

In addition, if it is determined that the autonomous driving vehicle 2 cannot reach the first candidate delivery location, the presentation unit 37 may present a reason why it is determined by the determination unit 34 that the vehicle cannot reach the first candidate delivery location together with the delivery location, to the user's mobile terminal 10. The reason may be because, for example, the cruising available distance is insufficient or the road is closed. In this way, by presenting the reason why the first candidate delivery location is not selected as the delivery location to the user, the autonomous driving delivery system 1 can reduce user's dissatisfaction with the fact that the first candidate delivery location is not designated as the delivery location.

Here, as described above, the first selection unit 33 can select a plurality of first candidate delivery locations. In this case, the presentation unit 37 presents the selected plurality of first candidate delivery locations to the user of the mobile terminal 10 who made the delivery request, and causes the user to select the first candidate delivery location (delivery location). The mobile terminal 10 transmits the result of selection by the user to the server 30. Then, the determination unit 34 determines whether or not the vehicle can reach the first candidate delivery location selected by the user. If it is possible to reach the first candidate delivery location selected by the user, the designation unit 36 may designate the first candidate delivery location selected by the user as luggage delivery location. In this case, the autonomous driving delivery system 1 can reflect the user's desire on the delivery location, and thus, it is possible to improve the convenience for the user.

Similarly, as described above, the second selection unit 35 can select a plurality of second candidate delivery locations. In this case, the presentation unit 37 presents the selected plurality of second candidate delivery locations to the user of the mobile terminal 10 who made the delivery request, and causes the user to select a second candidate delivery location (delivery location). The mobile terminal 10 transmits the result of selection by the user to the server 30. Then, the designation unit 36 may designate the second candidate delivery location selected by the user as the luggage delivery location. In this case, the autonomous driving delivery system 1 can reflect the user's desire on the delivery location, and thus, it is possible to improve the convenience for the user.

The map DB 38 is a database that stores the map information. The map DB 38 is stored in the storage 103 of the server 30, for example. The map information is data storing the position information of roads, road structures, buildings, and the like. The map information may include information relating to the stop locations. The registered vehicle DB 39 is stored in the storage 103 of the server 30, for example. The registered vehicle DB 39 stores a vehicle identification number of the autonomous driving vehicle 2, the information on the position of the autonomous driving vehicle 2, and the information on the luggage loaded on the autonomous driving vehicle 2 in association with each other.

### Processing by Autonomous Driving Delivery System

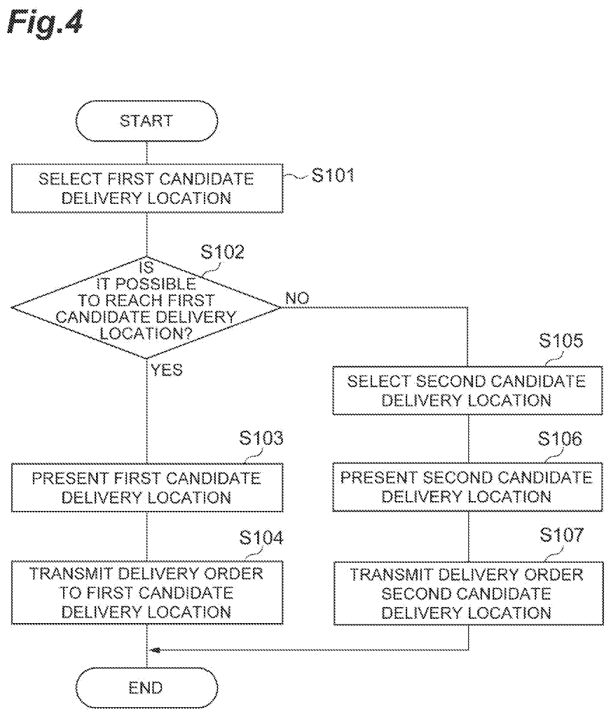

Next, a flow of delivery location presentation processing performed by the server 30 will be described using the flowchart in FIG. 4. The processing illustrated in FIG. 4 is started when a delivery request from the user is received by the delivery request reception unit 32.

As illustrated in FIG. 4, when the delivery request is received, the first selection unit 33 selects a first candidate delivery location from a plurality of stop locations (S101). The determination unit 34 determines whether or not the autonomous driving vehicle 2 can reach the selected first candidate delivery location (S102). If the autonomous driving vehicle 2 can reach the first candidate delivery location (YES in S102), the designation unit 36 designates the first candidate delivery location as the delivery location. The presentation unit 37 presents the designated delivery location (first candidate delivery location) to the user's mobile terminal 10 (S103). Subsequently, the designation unit 36 transmits a delivery order to the autonomous driving vehicle 2 on which the luggage of the user who made the delivery request is loaded, based on the designated delivery location (first candidate delivery location) (S104). In other words, the presentation of the delivery location to the user is performed before the autonomous driving vehicle 2 starts the delivery of the luggage toward the delivery location. Then, the user unlocks the delivery box in the autonomous driving vehicle 2 at the delivery location and receives the luggage.

On the other hand, if the autonomous driving vehicle 2 cannot reach the first candidate delivery location (NO in S102), the second selection unit 35 selects a second candidate delivery location where the autonomous driving vehicle 2 can reach from a plurality of stop locations (S105). The designation unit 36 designates the selected second candidate delivery location as the delivery location. Then, the presentation unit 37 presents the designated delivery location (second candidate delivery location) to the user's mobile terminal 10 (S106). Subsequently, the designation unit 36 transmits a delivery order to the autonomous driving vehicle 2 on which the luggage of the user who made the delivery request is loaded, based on the designated delivery location (second candidate delivery location) (S107). In other words, the presentation of the delivery location to the user is performed before the autonomous driving vehicle 2 starts the delivery of the luggage toward the delivery location. Then, the user unlocks the delivery box in the autonomous driving vehicle 2 at the delivery location and receives the luggage.

As the autonomous driving delivery system 1 in the present embodiment, when delivering the luggage by the autonomous driving vehicle 2, it is necessary to join the user with the autonomous driving vehicle 2 on which the luggage of the user is loaded. Therefore, if the autonomous driving vehicle 2 on which the luggage of the user is loaded cannot reach the first candidate delivery location, this second candidate delivery location where the autonomous driving vehicle 2 can reach is presented to the user. In this way, the autonomous driving delivery system 1 can cause the autonomous driving vehicle 2 on which the luggage of the user is loaded to join with the user at the second candidate delivery location, and then, the luggage can be transferred to the user at the second candidate delivery location.

As described above, in the autonomous driving delivery system 1, the first candidate delivery location is designated as the delivery location when the vehicle can reach the first candidate delivery location, and the second candidate delivery location is designated as the delivery location when the vehicle cannot reach the first candidate delivery location. The designated delivery location is presented to the user before the autonomous driving vehicle 2 starts the delivery of the luggage toward the delivery location. As described above, if the vehicle cannot reach the first candidate delivery location, the autonomous driving delivery system 1 designates the second candidate delivery location as the delivery location, and then, can start the delivery of the luggage by the autonomous driving vehicle 2 after presenting the designated delivery location to the user. In this way, the delivery location is not changed during the delivery, and thus, it is possible to prevent the user from feeling discomfort. As a result, the autonomous driving delivery system 1 can appropriately present the luggage delivery location to the user.

If it is determined that autonomous driving vehicle cannot reach the first candidate delivery location, the autonomous driving delivery system 1 may select a plurality of second candidate delivery locations and may present the result to the user, and then, may designate the second candidate delivery location selected by the user, as the delivery location. In this case, if the vehicle cannot reach the first candidate delivery location, the autonomous driving delivery system 1 can reflect the user's desire on the delivery location, and thus, it is possible to improve the convenience for the user.

If the autonomous driving vehicle 2 cannot return to the predetermined fueling or charging place via the first candidate delivery location, the determination unit 34 in the autonomous driving delivery system 1 may determine that the vehicle cannot reach the first candidate delivery location. In this case, if the first candidate delivery location is the delivery location, the autonomous driving delivery system 1 can prevent the autonomous driving vehicle 2 from being not possible to return to the fueling or charging place.

The stop location is a location at which parking or stopping of the autonomous driving vehicle is not legally prohibited. Therefore, the autonomous driving delivery system 1 can select a location at which the parking or stopping is not legally prohibited as the first candidate delivery location or the second candidate delivery location. Accordingly, the autonomous driving delivery system 1 can receive and transfer the luggage by stopping the autonomous driving vehicle 2 at the stop location while keeping the law.

The stop location may be a location on the road that satisfies a condition that “road width divided by vehicle width of the autonomous driving vehicle is equal to or greater than a predetermined ratio threshold value”. In this case, the autonomous driving delivery system 1 can select a location whose road width is wider than the vehicle width of the autonomous driving vehicle by the predetermined ratio threshold value as the first candidate delivery location or the second candidate delivery location. As a result, the autonomous driving delivery system 1 can stop the autonomous driving vehicle 2 at the stop location and can receive and transfer the luggage while suppressing hindrance of the traveling of other vehicles on the road.

The stop location may be a location provided with a parking section where the autonomous driving vehicle 2 can be parked or stopped. In this case, the autonomous driving delivery system 1 can stop the autonomous driving vehicle 2 and can receive and transfer the luggage at the location (the location where the parking section is provided) provided in advance for parking or stopping.

The present disclosure in the embodiment is described above, but the present disclosure is not limited to the embodiment described above. The present disclosure can be implemented in various forms including various modifications and improvements based on the knowledge of those skilled in the art including the above-described embodiment.

For example, the server 30 may be loaded on the vehicle. The server 30 may be loaded on an autonomous driving vehicle 2 used for delivery. That is, the ECU 20 of the autonomous driving vehicle 2 may include the functional configuration of the server 30. The server 30 may be a cloud server configured with servers loaded on the ECUs of a plurality of autonomous driving vehicles 2A . . . 2X.

The delivery location does not necessarily need to be a location where the user himself/herself receives the luggage from the autonomous driving vehicle 2, but may be a delivery location where a clerk of a convenience store, a concierge of an apartment, or a hotel employee can receive and temporarily keep the luggage.

The luggage delivery request is not limited to a case of being performed by a user who receives the luggage. For example, a sender who sends luggage to the user may make a request to the server 30 for the luggage delivery to user.

In the embodiment described above, the case where the luggage delivery request is performed using the user's mobile terminal 10 or the luggage delivery location is presented using the mobile terminal 10 is described as an example, but the luggage delivery request or the presentation is not limited to be performed using the mobile terminal 10. The luggage delivery request or the presentation may be performed by a device other than the mobile terminal 10.

What is claimed is:

1. An autonomous driving delivery system for delivering luggage to a delivery location by an autonomous driving vehicle based on a delivery request for delivering the luggage to a user, comprising:
a first selection unit configured to select a first candidate delivery location from a plurality of predetermined stop locations based on a position of the user, a past delivery history to the user, or the delivery location specified by the user, when the delivery request is made;
a determination unit configured to determine whether or not the autonomous driving vehicle can reach the first candidate delivery location based on at least one of a cruising available distance and road passability information of the autonomous driving vehicle;
a second selection unit configured to select a second candidate delivery location where the autonomous driving vehicle can reach, from the plurality of stop locations based on at least any one of the cruising available distance and the road passability information, if it is determined that the autonomous driving vehicle cannot reach the first candidate delivery location;
a designation unit configured to designate the first candidate delivery location as the delivery location if it is determined that the autonomous driving vehicle can reach the first candidate delivery location, and configured to designate the second candidate delivery location as the delivery location if it is determined that the autonomous driving vehicle cannot reach the first candidate delivery location; and
a presentation unit configured to present the designated delivery location to the user before the autonomous driving vehicle starts the delivery of the luggage to the delivery location designated by the designation unit.

2. The autonomous driving delivery system according to claim 1,
wherein the second selection unit is configured to select a plurality of second candidate delivery locations from the plurality of stop locations based on at least one of the cruising available distance and the road passability information,
wherein the presentation unit is configured to present the plurality of second candidate delivery locations selected by the second selection unit to the user if it is determined that the autonomous driving vehicle cannot reach the first candidate delivery location, and
wherein the designation unit is configured to designate the second candidate delivery location selected by the user as the delivery location.

3. The autonomous driving delivery system according to claim 1,
wherein the determination unit is configured to determine that the autonomous driving vehicle cannot reach the first candidate delivery location based on the cruising available distance and the road passability information if the autonomous driving vehicle cannot return to a predetermined fueling or charging place via the first candidate delivery location.

4. The autonomous driving delivery system according to claim 1,
wherein the stop location is a location where parking or stopping of the autonomous driving vehicle is not legally prohibited.

5. The autonomous driving delivery system according to claim 1,
wherein the stop location is a location on the road satisfying condition in which road width divided by vehicle width of autonomous driving vehicle is equal to or greater than a predetermined ratio threshold value.

6. The autonomous driving delivery system according to claim 1,
wherein the stop location is a location provided with a parking section where the autonomous driving vehicle can be parked or stopped.
